(19) United States
(12) Patent Application Publication
(10) Pub. No.: US 2002/0035913 A1
(43) Pub. Date: Mar. 28, 2002

(54) Keyboard device for musical instrument

(76) Inventor: Manabu Arimori, Shizuoka-ken (JP)

Correspondence Address: CROWELL & MORING LLP, Intellectual Property Group, P.O. Box 14300, Washington, DC, 20044-4300, US

(21) Appl. No.: 09/789,702

(22) Filed: Feb. 22, 2001

(30) Foreign Application Priority Data
Feb. 25, 2000 (JP) 049414/2000
Feb. 29, 2000 (JP) 053574/2000

(51) Int. Cl. G10C 3/12

(52) U.S. Cl. 84/423 R

(57) ABSTRACT

A keyboard device for a musical instrument is provided for reducing or eliminating weights made of lead, which are attached to a key, to reduce the weight of the musical instrument and to adapt for the environmental problem, as well for allowing the user to readily adjust a touch weight at a place other than a factory. A key is swingably supported by a balance pin at a central portion thereof. An action has a wippen pivotally supported by a wippen flange, and is carried on the key at a location behind the balance pin through the wippen. The wippen is applied with moment about the wippen flange in a direction in which the wippen is lifted up by a weight or a spring. The magnitude of the moment is adjusted by an adjuster screw.

### BACKGROUND OF THE INVENTION

1. Field of the Invention

The present invention relates to a keyboard device for a musical instrument such as a grand piano having actions, and more particularly, to a keyboard device which comprises a function of adjusting a touch weight.

2. Prior Art

FIG. 1 illustrates a conventional key device for a grand piano. This keyboard device 51 comprises a keyframe 52, and a number of keys 53 (only one white key and one black key are illustrated) and an action 54 carried on the keyframe 52. Each key 53 extends in the front-to-back direction, and is swingably supported in a central portion thereof by balance pins 55 implanted on the keyframe 52. Also, a capstan 56 is disposed on the top of the key 53 at a location behind the balance pins 55. The action 54, which is provided for each key 53, has a wippen 58 having a rear end portion pivotably mounted to a wippen flange 57, a pivotable hammer 59, and so on. The action 54 is carried on the key 53 through the wippen 58 and the capstan 56.

With the foregoing structure, when the key 53 is depressed, the key 53 is swung about the balance pin 55 to push up the wippen 58 through the capstan 56, causing the action 54 to actuate to pivot the hammer 59 upward, so that the hammer 59 strikes a string (not shown) to generate piano sound. A touch weight (static load) of the key 53 is determined by the balance of moment about the balance pin 55 between the weight of the key 53 and the weight of the action 54 carried thereon.

The keyboard device 51 is provided with a plurality of weights 60 for the key 53 in order to adjust the touch weight. The weights 60 are provided to add a weight to the key 53 in order to match for the weight of the action 54 and to provide a desired touch weight, and are each made of lead of a predetermined size molded into a cylindrical shape. Specifically, the weights 60 are inserted into a plurality of embedding holes 61 formed at positions in front of the balance pin 55 of the key 53, and caulked for fixation to the key 53. The lead is employed as the weights 60 in this manner because the lead has a high specific gravity among metals, is inexpensive, and exhibits high flexibility and ductility which facilitate works as mentioned above.

However, the conventional keyboard device 51 described above needs a number of weights 60 made of lead, which must be attached in order to provide a desired touch weight and match for the weight of the action 54, resulting in an increase in weight of the key 53 and an eventual increase in weight of the piano. In addition, this requires a heavy pedal stepping force, slow returning of the key 53, and so on when the keyframe 52 is shifted to produce a soft pedal effect. Also, although the weights 60 attached to a front portion of the key 53 result in a lighter touch weight of the key 53, this gives rise to disadvantages in terms of playing in that the key 53 experiences difficulties in returning upward after the key has been pressed so that a pound cannot be smoothly performed for trill and so on. Further, since the lead used as the weights 60 is an injurious material, it is desirable that lead is used as least frequently as possible in regard to countermeasures to the environment.

In addition, although adjusted optimally upon shipment from the factory, the touch weight often shifts from an optimal value due to installation conditions and use environment of the piano, so that readjustments may be required therefor. In this event, however, with the structure of the conventional keyboard device 51, the readjustment of a touch weight is quite laborious, and the readjustment in a place other than a factory is virtually difficult since the readjustment can be carried out only by cutting away a side face of a weight 60, or newly forming an embedding hole 61 into the key 53 to embed an additional weight 60 therein.

### SUMMARY OF THE INVENTION

To solve the problems as mentioned above, it is an object of the present invention to provide a keyboard device for a musical instrument which is capable of reducing or eliminating weights made of lead, which are attached to a key, to reduce the weight of the musical instrument and to adapt for the environmental problem, as well as capable of allowing the user to readily adjust a touch weight in a place other than a factory.

This object is achieved by a keyboard device for a musical instrument according to the present invention which comprises a key extending in a front-to-back direction and swingably supported by a balance pin at a central portion, an action having a wippen flange and a wippen pivotably supported by the wippen flange, and placed at a location of the key behind the balance pin through the wippen, moment applying means for applying the wippen with moment about the wippen flange in a direction in which the wippen is lifted up, and moment adjusting means for adjusting the magnitude of the moment.

According to this keyboard device for a musical instrument, as is normally the case, the action has the wippen pivotably supported by the wippen flange, and is carried on the key at a location behind the balance pin through the wippen. The wippen is applied with moment, by the moment applying means, about the wippen flange in the direction in which the wippen is lifted up. The weight of the action acting on the key through the wippen is reduced by this moment. As a result, it is possible to reduce or eliminate the conventional weights made of lead, which are attached to the key for providing a desired touch weight, to match for the weight of the action, thereby reducing the weight of the piano and adapting for the environmental problem. Also, the weight of the action acting on the key, and therefore a touch weight can be adjusted by adjusting the magnitude of the moment by the moment adjusting means.

In this event, preferably, the wippen has a body portion pivotably attached to the wippen flange, extending toward one of forward and backward directions from the wippen flange, and carried on the key, and a weight attaching portion extending toward the other of the forward and backward directions from the wippen flange opposite to the body portion, and the moment applying means has a weight attached to the weight attaching portion of the wippen.

In this configuration, the weight is attached to the weight attaching portion of the wippen which extends in the direction opposite to the body portion from the wippen flange. Thus, the wippen is applied by the load of the weight with the moment acting on the wippen about the wippen flange in the direction in which the body portion is lifted up, so that the weight of the action can be reduced correspondingly.

Further in this event, preferably, the weight attaching portion of the wippen has a threaded hole, and the weight comprises at least one weight body formed with a throughhole, and an attaching screw inserted through the throughhole of the weight body and screwed into the threaded hole of the weight attaching portion to attach the weight body to the weight attaching portion.

In this configuration, the weight is attached to the wippen by inserting the attaching screw through the throughhole of the weight body and screwing the attaching screw into the threaded hole formed in the weight attaching portion. Therefore, for example, a plurality of weight bodies having the same weight or different weights from one another may have been previously provided, such that a single suitable weight or a combination of such weight bodies are selected from them, and attached with the attaching screw. Thus, the touch weight can be readily adjusted, for example, in a place other than a factory by changing the moment about the wippen flange with the load of the weight. Also, this configuration is a simple one which only involves forming the threaded hole into an existing wippen, forming the weight bodies having a throughhole, and attaching them with the attaching screw, so that the weight can be implemented at a low price without causing a significant increase in cost. Furthermore, since the weight body itself only need be formed to have the throughhole, without requirements of high workability, as is the case with the conventional attachment by caulking, it can be readily formed of a material other than lead.

Further in this event, preferably, the weight is inserted through by the attaching screw, and further has a coil spring sandwiched between the weight attaching portion and the weight body.

In this configuration, the touch weight can be accurately adjusted in a continuous manner by changing the amount of compression of the coil spring by turning the attaching screw, with the weight left attached, to change the distance from a pivotal fulcrum to the weight body and eventually change the moment about the wippen flange. Also, since the touch weight can be adjusted only by turning the attaching screw with the weight left attached, the adjustment of the touch weight can be made more readily. In this case, by combining such adjustment by means of the attaching screw with the aforementioned adjustment by means of the load of the weight body, the touch weight can be finely adjusted in a wider range.

In these events, preferably, the weight body is made of a material other than lead.

In this configuration, the weight can be made without using injurious lead by employing, for example, a metal having a high specific gravity other than lead, a composite material produced by blending such a metal with plastic, and so on as materials for the weight.

Alternatively, it is preferable that the moment applying means has a spring supported by the wippen flange for urging the wippen in a direction in which the wippen is lifted up about the wippen flange, and the moment adjusting means has an adjuster screw, movably screwed into the wippen and having a leading end abutting to the spring, for adjusting an urging force of the spring in accordance with a height position thereof.

According to this configuration, since an urging force of the spring and the moment about the wippen flange applied thereby can be continuously adjusted by turning the adjuster screw in screw engagement with the wippen to adjust the height position thereof, the touch weight can be readily and accurately adjusted.

In this event, preferably, the wippen is formed with a threaded hole for the adjuster screw to be screwed thereinto, and a spring accommodating portion continuous to the threaded hole, wherein the spring is at least partially accommodated in the spring accommodating portion, and has one end fixed to the wippen flange and the other end in an abutting relationship with the adjusting screw.

According to this configuration, it is only required to form the wippen with the spring accommodating portion and the threaded hole, and accommodate the spring in the spring accommodating portion and screw the adjuster screw into the threaded hole, thus providing a simple configuration. Also, since at least a portion of the spring is accommodated in the spring accommodating portion, a compact configuration can be provided.

### BRIEF DESCRIPTION OF THE DRAWING

FIG. 1 is a side view illustrating a conventional keyboard device for a grand piano;

FIG. 2 is a side view of a keyboard device for a grand piano according to a first embodiment of the present invention;

FIG. 3 is a side view illustrating an action of the keyboard device in FIG. 2 together with a portion of a key;

FIG. 4 is a diagram illustrating the structure of weights, and how the weights are attached to the action;

FIG. 5A is a diagram illustrating weights according to an exemplary modification before they are attached;

FIG. 5B is a diagram illustrating the weights of FIG. 5 after they have been attached;

FIG. 6 is a perspective view illustrating a portion of an action in a keyboard device for an upright piano according to a second embodiment of the present invention;

FIG. 7 is a diagram illustrating an exemplary modification to a weight body;

FIG. 8 is a side view illustrating an action in a keyboard device for a grand piano according to a third embodiment of the present invention together with a portion of a key;

FIG. 9 is a perspective view illustrating a spring and an adjuster screw for the action in FIG. 8;

FIG. 10 is a cross-sectional view corresponding to FIG. 9;

FIG. 11 is a perspective view illustrating a portion of an action in a keyboard device for an upright piano according to a fourth embodiment of the present invention;

FIG. 12 is a partial cross-sectional view corresponding to FIG. 10;

FIG. 13 is a partial cross-sectional view illustrating an exemplary modification to a grand piano; and

FIG. 14 is a partial cross-sectional view illustrating an exemplary modification to an upright piano.

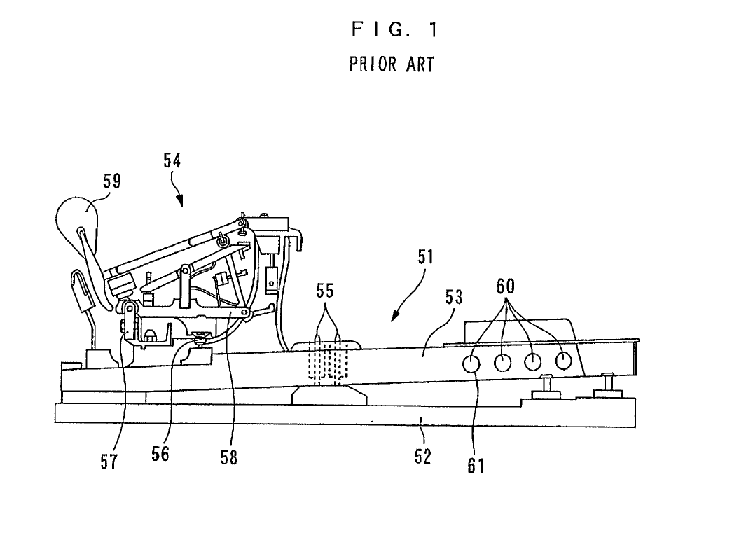

### DESCRIPTION OF THE EMBODIMENT

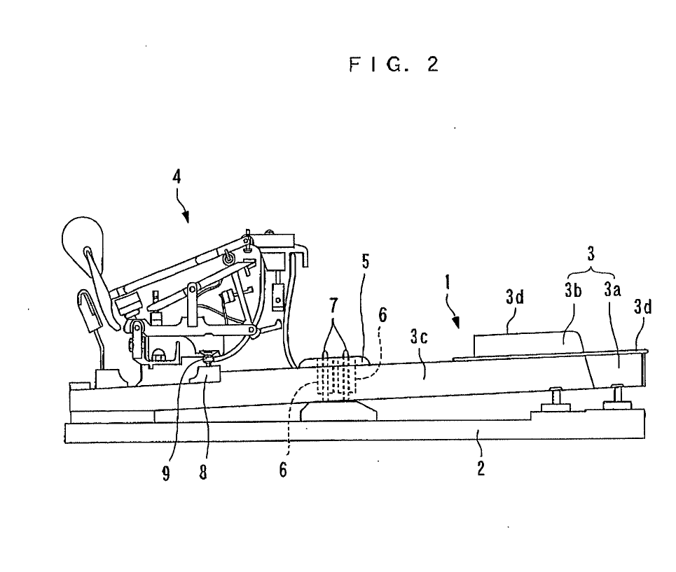

In the following, preferred embodiments of the present invention will be described with reference to the drawings. FIGS. 2 through 4 illustrate a keyboard device for a grand piano to which the present invention is applied. As illustrated in FIG. 2, this keyboard device 1 comprises a keyframe 2 horizontally carried on a keybed, not shown, a number of keys 3 arranged on the keyframe 2 (only one white key 3a and one black key 3b are shown), an action 4, and so on.

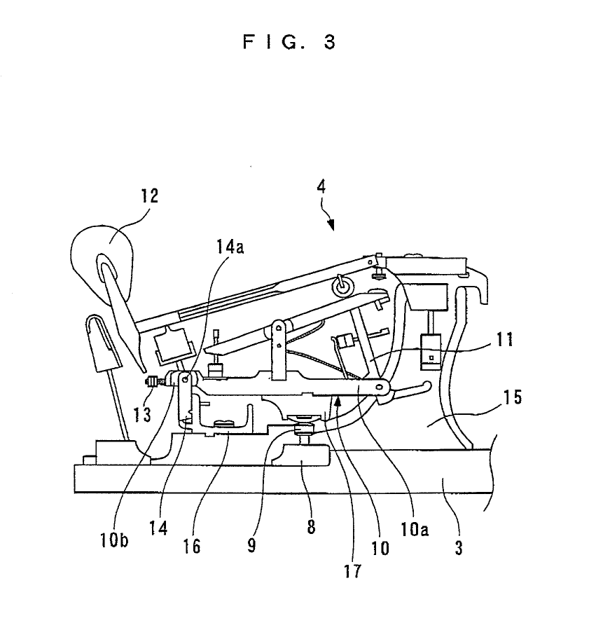

Each key 3 has a key body 3c made of a wood material, which extends in the front-to-back direction and a key cover 3d made of a plastic molding, attached to the top of the key body 3c. A middle seat plate 5 is attached to the top of the key body 3c in a central portion, and balance pin holes 6 are formed vertically through the middle seat plate 5. With the balance pin holes 6 engaging with balance pins 7 implanted on the keyframe 2, the key 3 is swingably supported by the balance pins 7. Also, a capstan 9 is attached to the top of the key 3 through a front seat plate 8 at a location behind the balance pin holes 6 (see FIG. 3). It should be noted that conventional weights made of lead are not attached to the key body 3c.

The action 4 is provided for each key 3, and, as illustrated in FIG. 3, has a wippen 10 extending in the front-to-back direction; a jack 11 pivotably attached to the wippen 10 and extending upward; a pivotable hammer 12 disposed above the jack 11; a weight 13 attached to the rear end of the wippen 10; and so on. Above the hammer 12, a string (not shown) is stretched extending in the front-to-back direction.

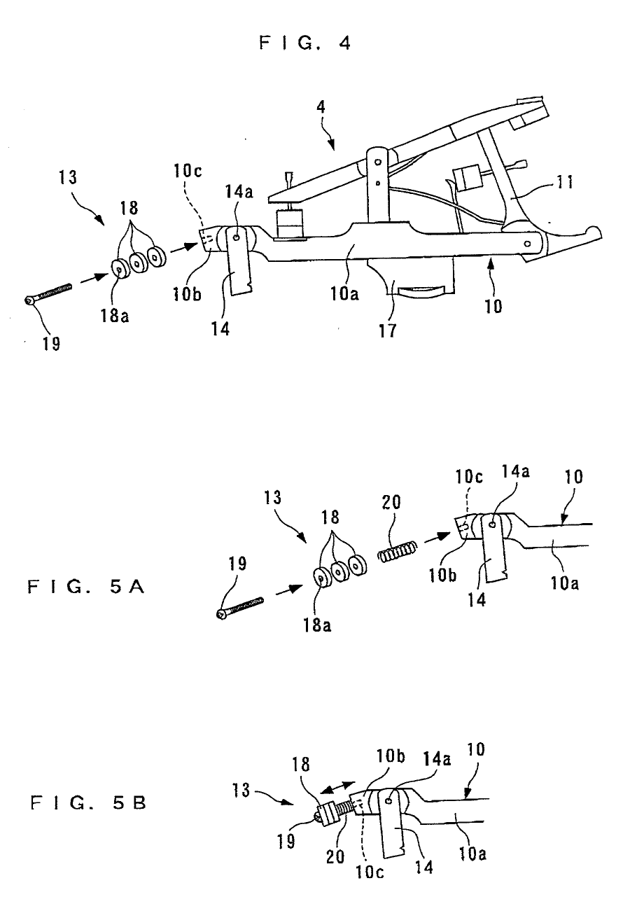

The wippen 10, which is comprised of a plastic molding, is pivotably supported near the rear end thereof by a pivotal fulcrum 14a of a wippen flange 14. The wippen 10 comprises a portion largely extending forward of the pivotal fulcrum 14a, designated as a body portion 10a; and a portion slightly extending backward, designated as a weight attaching portion 10b. On the back of the weight attaching portion 10b, a threaded hole 10c is formed for attaching the weight 13 (see FIG. 4). The wippen flange 14 is fixedly screwed on a wippen rail 16 which extends between a left and a right bracket 15, 15 (only one of which is shown). Also, a wippen heel 17 is integrally arranged on the bottom side of the body portion 10a of the wippen 10, and this wippen heel 17 is carried on the capstan 9 of the key 3.

As illustrated in FIGS. 3 and 4, the weight 13 is comprised of at least one weight body 18 (three in this example) for adjusting a touch weight; and an attaching screw 19 for attaching the weight bodies 18 to the wippen 10. The weight body 18 is in the shape of a disk (troidal plate) having a throughhole 18a at the center. In addition, a plurality of weight bodies 18 having the same weight or different weights from each other have been previously provided as the weight bodies 18, so that a variety of weights can be provided as the overall weight bodies 18 by selecting a single weight body having a suitable weight or a combination of such weight bodies from them.

Also, the weight bodies 18 are made of a metal having a relatively high specific gravity, preferably a metal other than lead, for example, tungsten, iron or the like, or a composite material produced by blending one of these metals with a plastic, for example, a composite material of tungsten and nylon, or the like. Tungsten is particularly preferred as a metal for the composite material since it is harmless and has a very large specific gravity, so that it is particularly suitable for achieving a specific gravity with a blend of another material. Nylon, in turn, is preferred since it is relatively superior in toughness and high impulse resistance among plastic materials, and therefore suitable as a base resin for the weight 4, as well as it is also superior in moldability as it is apt to injection molding. The weight bodies 18 of the foregoing structure is attached to the weight attaching portion 10b of the wippen 10 by screwing and fastening the attaching screw 19, inserted through the throughhole 18, into the threaded hole 10c of the wippen 10, as illustrated in FIG. 4.

With the structure described above, as the key 3 is pressed, the key 3 is swung about the balance pins 7, causing the action 4 to actuate in association. More specifically, as the wippen 10 is pushed up through the capstan 9, the wippen 10 is pivoted upward about the pivotal fulcrum 14a of the wippen flange 14, and in association therewith, the jack 11 pushes up the hammer 12, resulting in upwardly pivotal movement of the same. Thus, the hammer 12 strikes a string stretched above to generate piano sound.

The touch weight of the key 3 is determined by the balance of moment about the balance pins 7 between the weight of the key 3 and the weight of the action 4 carried thereon through the body portion 10a of the wippen 10. As described above, in this keyboard device 1, the weight 13 is attached to the weight attaching portion 10b extending in the direction opposite to the body portion 10a, with the pivotal fulcrum 14a interposed therebetween. Therefore, the wippen 10 is applied with moment about the pivotal fulcrum 14a acting in a direction in which the body portion 10a is lifted up, due to the load of the weight body 18 of the weight 13. The weight of the action 4 acting on the key 3 through the wippen 10 is reduced by this moment. As a result, it is possible to reduce or eliminate the conventional weights made of lead, which are attached to the key 3 to match for the weight of the action 4, so that a desired touch weight is provided. In this embodiment, this is eliminated. It is therefore possible to accomplish a reduction in the weight of the piano and adaptation for the environmental problem.

In addition, since the weight of the overall weight bodies 18 can be adjusted by selecting a single suitable weight or a combination of such weights from a plurality of the weight bodies 18, the weight of the action 4 acting on the key 3, and hence the touch weight can be adjusted by changing the moment about the pivotal fulcrum 14a. It is therefore possible to readily adjust the touch weight in a place other than a factory. Further, this embodiment provides a simple structure which only involves forming the threaded hole 10a into the existing wippen, forming the weight bodies 18 having a throughhole 18, and attaching them with the attaching screw 19, so that the weight can be implemented at a low price without causing a significant increase in cost. Furthermore, since the weight bodies 18 themselves only need be formed to have the throughhole 18a, without requirements of high workability, as is the case with conventional attachment by caulking, the weight bodies 18 can be readily formed of a material other than lead, thereby making it possible to make the weight 13 harmless.

FIGS. 5A and 5B illustrate an exemplary modification to the weight 13. As illustrated in the figures, a coil spring 20 is added to the weight 13. The coil spring 20 is arranged between the weight attaching portion 10b and the weight bodies 18, such that the attaching screw 19 is inserted therethrough, and is attached in a state in which it is sandwiched between the weight attaching portion 10b and the weight bodies 18 by fastening the attaching screw 19.

Thus, according to this exemplary modification, as illustrated in FIG. 5(b), the touch weight can be accurately adjusted in a continuous manner by changing the amount of compression of the coil spring 20 by turning the attaching screw 19, with the weight 13 left attached, to change the distance from the pivotal fulcrum 14a to the weight bodies 18 and eventually change the moment about the pivotal fulcrum 14a. Also, since the touch weight can be adjusted only by turning the attaching screw 19 with the weight 13 left attached, the adjustment of the touch weight can be made more readily than the case of FIG. 4. Further, by combining such adjustment by means of the attaching screw 19 with the aforementioned adjustment by means of the load of the weight bodies 18, the touch weight can be finely adjusted in a wider range.

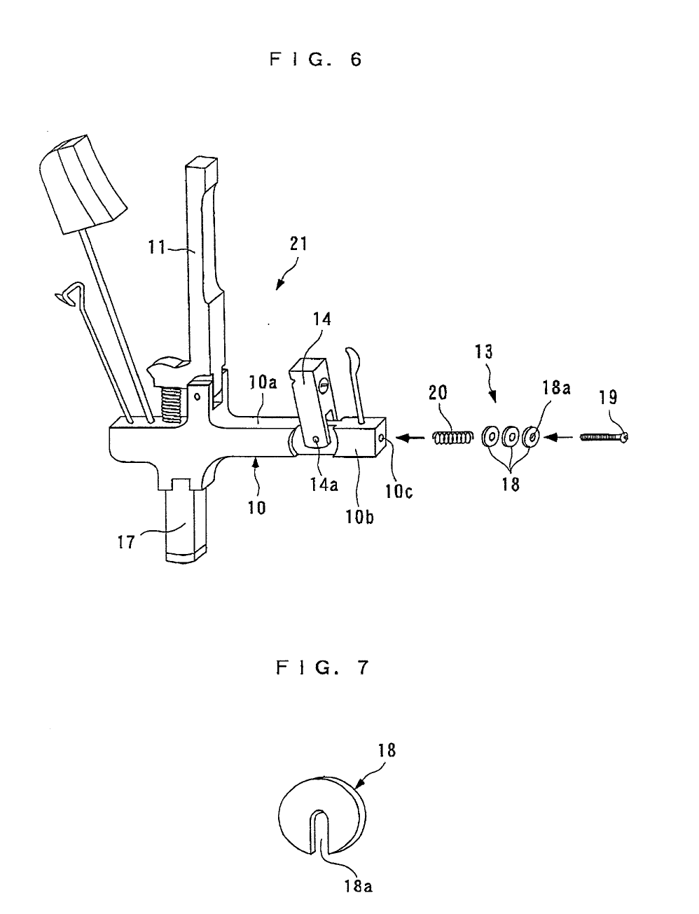

FIG. 6 illustrates a second embodiment of the present invention. In this embodiment, the present invention is applied to an upright piano. FIG. 6 illustrates a portion of an action therefor. This action 21 is identical in the basic structure to the aforementioned action 4 for a grand piano, though different in the shape and arrangement, so that corresponding components are designated the same reference numerals for simplifying the explanation. The action 21 comprises a wippen 10 pivotably supported by a pivotal fulcrum 14a of a wippen flange 14; a jack 11 pivotably attached to the wippen 10 for pushing up an overlying hammer (not shown); and so on.

A body portion 10a of the wippen 10, extending backward of the pivotal fulcrum 14a, is carried on a capstan screw arranged on a key (both not shown) through a wippen heel 17. Also, a threaded hole 10c is formed into the front face of a weight attaching portion 10b of the wippen 10 protruding forward of the pivotal fulcrum 14a. A weight 13, similar in structure to the second embodiment, i.e., the weight 13 comprised of a weight body 18, an attaching screw 19 and a coil spring 20 is attached to this threaded hole 10c. Therefore, completely similar effects to those of the exemplary modification illustrated in FIGS. 5A and 5B can be produced as well in this example of upright piano. It should be noted that the coil spring 20 of the weight 13 may be omitted, i.e., the weight 13 illustrated in FIG. 4 can of course be applied to the action 21 for an upright piano.

While in the aforementioned two embodiments, the weight body 18 is formed in the shape of a troidal plate having a circular throughhole 18a at the center, the weight body 18 itself and the throughhole 18a may be in other suitable shapes as long as they can be attached with the attaching screw 19. For example, the weight body 18 may be formed in the shape of block. Alternatively, as illustrated in FIG. 7, the throughhole 18a may be formed in an elongated hole which extends from the vicinity of the center of the weight body 18 to an outer edge. This structure allows the weight body 18 to be removed for replacement with the attaching screw 18 left attached to the weight attaching portion 10b, thereby making it possible to more readily adjust the touch weight.

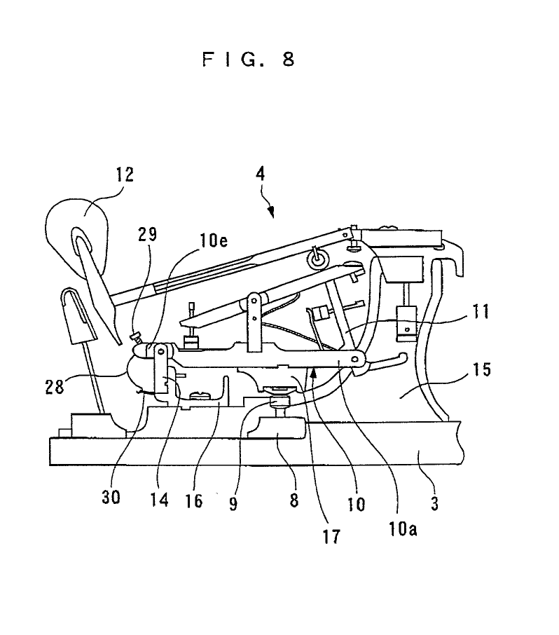

FIGS. 8 through 10 illustrate a keyboard device for a grand piano according to a third embodiment of the present invention. Since this keyboard device differs from the aforementioned keyboard device of the first embodiment only in the structure of a portion of the action 4, the same components are designated the same reference numerals, and explanation thereon is basically omitted. The explanation will therefore be centered on different aspects. As illustrated in FIG. 8, in addition to a wippen 10, a jack 11 and a hammer 12, this action 4 has a spring 28 and an adjuster screw 29 attached to the rear end of the wippen 10.

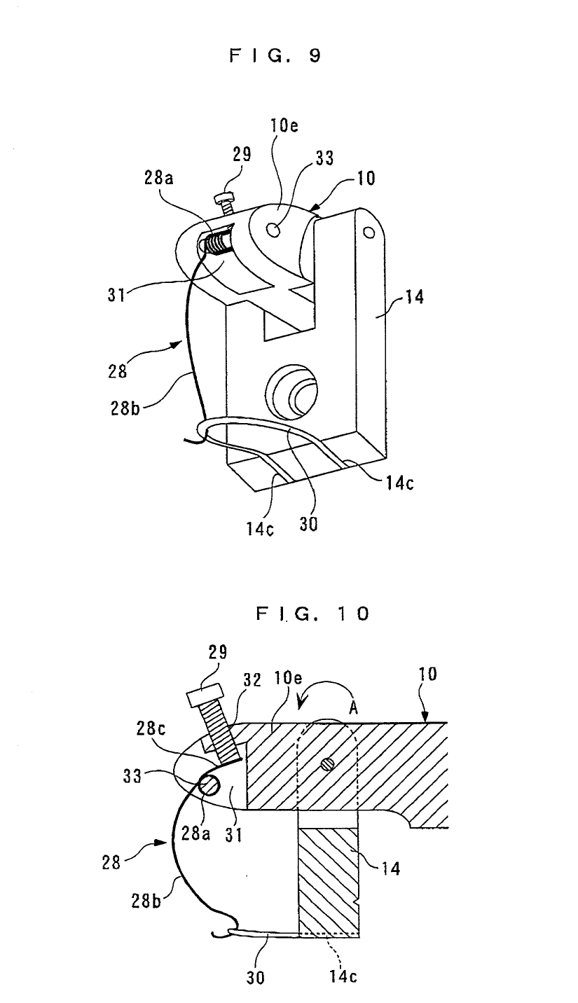

The wippen 10 extends slightly backward of a wippen flange 14, and this portion serves as a spring attaching portion 10e. Also, as illustrated in FIG. 9, a left and a right code attaching groove 14c, 14c are formed in two columns on the lower face of the wippen flange 14. Both ends of a code 30 made, for example, of cloth are inserted into and adhered in these code attaching grooves 14c, 14c, so that the code 30 is attached in a ring shape so as to extend backward of the wippen flange 14.

As illustrated in FIGS. 9 and 10, a spring accommodating recess 31 is formed at the center of the back of the spring attaching portion 10e of the wippen 10 for accommodating the spring 28, while a threaded hole 32 is formed on the top of the wippen 10 to be continuous to the spring accommodating recess 31 for the adjuster screw 29 to be in screw engagement therewith. Also, a pin 33 is attached horizontally to the spring attaching portion 10e to traverse the spring accommodating recess 31.

The spring 28, which is formed by winding a wiring material made of steel or the like in a predetermined shape, is comprised of a coil portion 28a; a curved portion 28b which largely curves from one end of the coil portion 28a and extends downward; and a screw abutting portion 28c extending slightly from the other end of the coil portion 28a. The coil portion 28a of the spring 28 is accommodated in the spring accommodating recess 31 of the wippen 10, and passed through and attached to the pin 33. The curved portion 28b, deflected toward the wippen flange 14, is fastened to the code 30 in a curling portion of the lower end thereof. Therefore, a resilient spring force of the curved portion 28b acts downward on the spring attaching portion 10e of the wippen 10 through the pin 33 at all times, i.e., urges the wippen 10 at all times in a direction in which the wippen 10 is lifted up about the wippen flange 14 (in a direction of the arrow A in FIG. 10). Therefore, as in the aforementioned first and second embodiments, a weight attached to the key 3 is eliminated, so that the key 3 can be reduced in weight.

Also, the adjuster screw 29 is movably screwed into the threaded hole 32 of the spring attaching portion 10e of the wippen 10 from above. A leading end thereof protrudes into the spring accommodating recess 31 and abuts to the spring abutting portion 28c of the spring 28 from above. Therefore, the tension of the curved portion 28b of the spring 28, i.e., an urging force of the spring 28 acting on the wippen 10 can be continuously adjusted by turning the adjuster screw 29 to adjust its height position. In this way, the moment about the wippen flange 14 can be continuously adjusted, so that a touch weight can be accurately adjusted. Further, since the touch weight can be adjusted only by turning the adjuster screw 29 externally by a screw driver, the adjustment can be readily made even in a place other than a factory. Moreover, this embodiment only involves forming the spring accommodating recess 31 and the threaded hole 32 in the wippen 10, and accommodating the spring 28 in the spring accommodating recess 31 and screwing the adjuster screw 29 into the threaded hole 32, thereby making it possible to realize the assembly at a low price. In addition, since the spring 28 is accommodated in the spring accommodating recess 31, the action 4 can be made in compact.

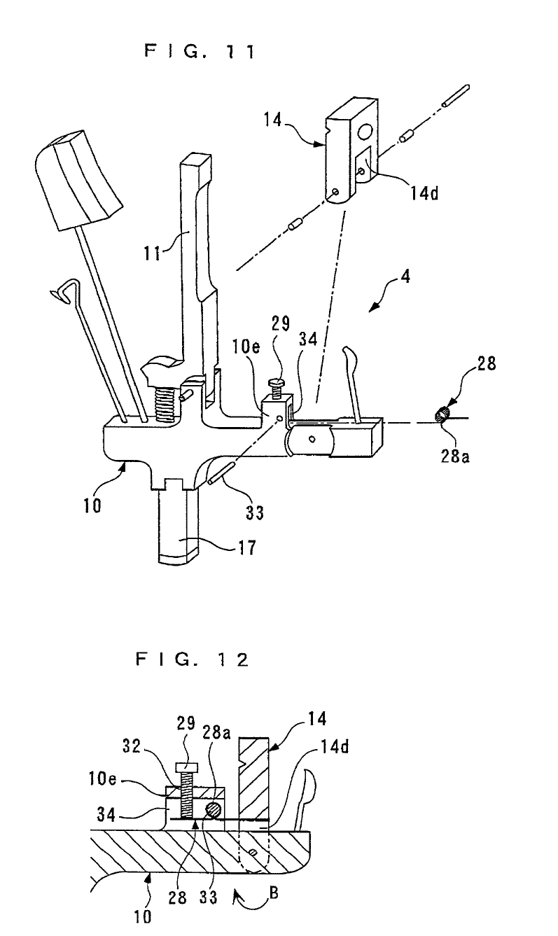

FIGS. 11 and 12 illustrate a fourth embodiment of the present invention. In this embodiment, the present invention is applied to an upright piano. Since the fourth embodiment differs from the aforementioned second embodiment only in the structure of a portion of the action 21, the same components are designated the same reference numerals, and explanation will be centered on different aspects. A spring attaching portion 10e is disposed integrally with a wippen 10 of this action 21 in close proximity to the back side of a wippen flange 14 such that the spring attaching portion 10e protrudes upward. As illustrated in FIG. 12, the spring attaching portion 10e is formed with a spring accommodating hole 34 which extends therethrough in the front-to-back direction, and a pin 33 is attached horizontally so as to traverse the spring accommodating hole 34.

Also, a spring 28 is comprised of a twisted coil spring. Its coil portion 28a is accommodated in the spring accommodating hole 34 and attached to the pin 33, and one end thereof is fastened to a top face of a notch 14d of the wippen flange 14. An adjuster screw 29 is movably screwed from above into a threaded hole 32 formed in an upper wall of the spring attaching portion 10e, and its leading end protrudes into the spring accommodating hole 34 and abuts to the other end of the spring 28 from above.

With the foregoing structure, according to this embodiment, a spring force of the spring 28 acts on the wippen 10 at all times in a direction in which the wippen 10 is lifted up (in a direction of the arrow B in FIG. 12) through the adjuster screw 29. The urging force of the spring 28 can be adjusted by adjusting a height position of the adjuster spring 29. Therefore, the effects produced by the aforementioned third embodiment applied to a grand piano can be provided completely in a similar manner for an upright piano as well.

Also, since the notch 14d of the wippen flange 14 is generally formed in the wippen 14 for attaching the wippen 10 therethrough, this embodiment can be implemented at a low price and in compact as in the third embodiment without adding any modifications to the existing wippen flange 14.

It should be noted that the configuration, arrangement and so on of the spring 28 and the adjuster screw 29 illustrated in the third and fourth embodiments are illustrative in any aspect, and that they may be modified as appropriate as long as the wippen 10 is urged by this spring 28 upward at all times in the direction in which the wippen 10 is lifted up, and the urging force can be adjusted by the adjuster screw 29.

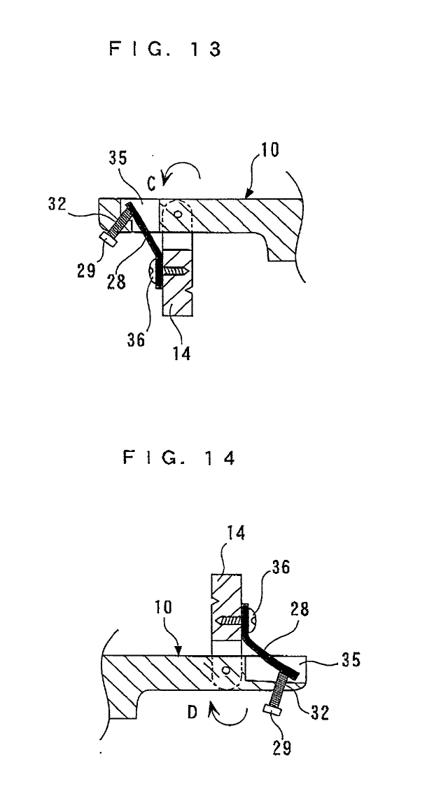

FIGS. 13 and 14 illustrate such exemplary modifications for a grand piano and an upright piano, respectively. Specifically, in these exemplary modifications, the spring 28 is comprised of a plate spring, one end of which is fixed to the wippen flange 14 with a screw 36, and the other end of which is accommodated in a spring accommodating portion 35 formed in the wippen 10 and brought into contact with the adjuster screw 29 which is screwed into the wippen 10. According to this structure, an urging force of the spring 28 acts on the wippen 10 through the adjusting screw 29 at all time in a direction in which the wippen 10 is lifted up (in a direction of the arrow C or D, respectively), and the urging force can be adjusted with the adjuster screw 29, thereby making it possible to produce similar effects to those of the aforementioned third and fourth embodiments. In addition, since the spring 28 is comprised of a simple plate spring and the spring 28 is simply screwed to eliminate the pin 33 as in the third and fourth embodiments, the structure can be provided at a lower price.

Further, while the touch weight is adjusted by the weight 13 and so on in the first and second embodiments and by the spring 28 and so on in the third and fourth embodiments to completely eliminate weights attached to the key 3, a portion of the weights in the key 3, made of a material other than lead, may be left in combination with the weight 13 and so on or with the spring 28 and so on. Also, while the embodiments have shown examples in which the present invention is applied to an acoustic grand piano and upright piano, the present invention can be applied to all musical instruments which have actions with wippens, such as a grand type electronic piano.

It will be understood by those skilled in the art that the foregoing is a description on the preferred embodiments of the present invention, and a variety of modifications can be made without departing from the spirit and scope of the invention.

What is claimed is:

1. A keyboard device for a musical instrument comprising:
a key extending in a front-to-back direction and swingably supported by a balance pin at a central portion;
an action having a wippen flange and a wippen pivotably supported by said wippen flange, and placed at a location of said key behind said balance pin through said wippen;
moment applying means for applying said wippen with moment about said wippen flange in a direction in which said wippen is lifted up; and
moment adjusting means for adjusting the magnitude of said moment.

2. A keyboard device for a musical instrument according to claim 1, characterized in that:
said wippen has a body portion pivotably attached to said wippen flange, extending toward one of forward and backward directions from said wippen flange, and carried on said key, and a weight attaching portion extending toward the other of the forward and backward directions from said wippen flange opposite to said body portion; and
said moment applying means has a weight attached to said weight attaching portion of said wippen.

3. A keyboard device for a musical instrument according to claim 2, characterized in that:
said weight attaching portion of said wippen has a threaded hole; and
said weight comprises at least one weight body formed with a throughhole, and an attaching screw inserted through said throughhole of said weight body and screwed into said threaded hole of said weight attaching portion to attach said weight body to said weight attaching portion.

4. A keyboard device for a musical instrument according to claim 3, characterized in that said weight is inserted through by said attaching screw, and further has a coil spring sandwiched between said weight attaching portion and said weight body.

5. A keyboard device for a musical instrument according to claim 3, characterized in that said weight body is made of a material other than lead.

6. A keyboard device for a musical instrument according to claim 4, characterized in that said weight body is made of a material other than lead.

7. A keyboard device for a musical instrument according to claim 1, characterized in that:
said moment applying means has a spring supported by said wippen flange for urging said wippen in a direction in which said wippen is lifted up about said wippen flange; and
said moment adjusting means has an adjuster screw, movably screwed into said wippen and having a leading end abutting to said spring, for adjusting an urging force of said spring in accordance with a height position thereof.

8. A keyboard device for a musical instrument according to claim 7, characterized in that said wippen is formed with a threaded hole for said adjuster screw to be screwed thereinto, and a spring accommodating portion continuous to said threaded hole, wherein said spring is at least partially accommodated in said spring accommodating portion, and has one end fixed to said wippen flange and the other end placed in an abutting relationship with said adjusting screw.
